(19) United States
(12) Patent Application Publication
(10) Pub. No.: US 2023/0360146 A1
(43) Pub. Date: Nov. 9, 2023

(54) CUSTOMER SUPPORT COMPLAINT MANAGEMENT

(71) Applicant: Wells Fargo Bank, N.A., San Francisco, CA (US)

(72) Inventors: Rameshchandra Bhaskar Ketharaju, Hyderabad (IN); Manpreet Singh, Hyderabad (IN); Mallikarjun Yadav Attena, Hyderabad (IN); Piyush Wani, Madhya Pradesh (IN); Sandeep Thati, Hyderabad (IN); Lakshmi Sailaja Mannepalli, Hyderabad (IN); Utkarsh Mishra, Fatehpur (IN)

(21) Appl. No.: 16/570,502

(22) Filed: Sep. 13, 2019

(51) Int. Cl. G06Q 50/00; G06Q 30/00

(52) U.S. Cl. CPC G06Q 50/01; G06Q 30/016

(57) ABSTRACT

Customer support is provided in response to complaints raised on social media platforms. Social media data of users is monitored to detect social media data that is negatively associated with an entity including a complaint regarding the entity. Detected social media data can be subsequently analyzed to determine whether it pertains to a technical complaint or non-technical complaint. A solution can be determined and provided to a user based on classification of the complaint as technical or non-technical.

Individuals, businesses, financial institutions, and other entities continue to maintain social media presence on social network platforms. Entities utilize social networks to advertise and interact with individuals. Individuals are increasingly taking advantage of the many social media channels to voice complaints. Oftentimes customers express frustrations or complaints with regard to entities using social media. For example, customers can post a complaint about a purchased product or service on social media.

### SUMMARY

The following presents a simplified summary to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to customer support management associated with social media complaints. Social media networks are monitored to detect social media that is negatively associated with an entity such as a complaint regarding the entity or product or service of the entity. A detected complaint can subsequently be analyzed and classified as either technical or non-technical. Solutions can be automatically determined based at least in part on the classification and provided to a complainant. Technical complaints can be further analyzed and compared to prior technical complaints and solutions to those complaints. If there is a match between a current and prior technical complaint, the prior solution can be return to the complainant. If no match is found, the technical complaint can be further classified and routed to an appropriate support team. If the complaint is non-technical, a solution can be set up to put the complainant in contact with a support team to address the complaint.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

FIG. 1 depicts an overview of an example implementation.

FIG. 2 is a schematic block diagram of a customer support system.

FIG. 3 is a schematic block diagram of an example filter component.

FIG. 4 is a schematic block diagram of an example solution component.

FIG. 5 is a flow chart diagram of a method of customer support complaint management.

FIG. 6 is an example implementation of a customer support system.

FIG. 7 is a schematic block diagram illustrating a suitable operating environment for aspects of the subject disclosure.

### DETAILED DESCRIPTION

Digital communication is becoming the predominant communication channel between entities and customers. An entity, such as a financial institution, can employ digital communication to educate customers about products or services offered. In turn, customers provide feedback that can be utilized by the entity to improve quality of products or services offered. In one particular instance, social media platforms can be employed by entities and customers. However, a noticeable pattern has emerged in which customers tend to post complaints on social media platforms rather than reaching out to customer support. As such, entities are unaware of these complaints, customers are not provided customer service to address their complaints, and entity reputation can be negatively impacted.

Details provided herein generally pertain to provisioning customer support for complaints posted on social media. Social media feeds can be automatically monitored to detect a complaint regarding an entity or product or service of the entity by way of content analysis. Subsequently, a detected social media post can be further analyzed to determine whether the complaint is technical or non-technical. For a technical complaint, a complaint pattern can be compared with previous patterns and corresponding solutions. If a similar complaint is found, the customer can be provided with the corresponding solution in response to the complaint. Otherwise, the technical complaint is categorized and forwarded to a relevant customer support team to provide a solution for the customer. For a non-technical issue, options can be provided for further support including contacting a customer to set up an appointment with a local support team to resolve the issue. As a result, entities are able to detect and respond to complaints and thereby improve customer service and reputation.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

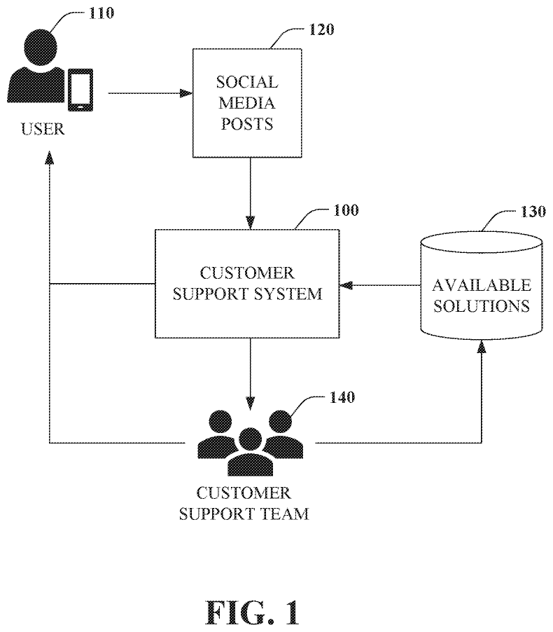

Referring initially to FIG. 1, an overview of an example implementation is illustrated and described. As shown, the implementation includes customer support system 100 that enables customer support to be provided in response to issues or complaints raised on social media platforms. User 110, by way of a computing device, can write a plurality of social media posts 120 on one or more social media platforms. In one instance, a post can correspond to a status update that includes a complaint regarding a product or service. The customer support system 100 monitors the social media posts 120 and identifies one or more social media posts 120 that correspond to an issue or complaint regarding products or services of an entity such as a bank. For example, text analysis can be utilized to identify particular hashtags or keywords corresponding to an entity or products or services of the entity.

The customer support system 100 can determine whether an identified issue or complaint is of technical or non-technical character. If technical, the customer support system 100 compares the detected issue or complaint with a repository of available solutions 130. If an available solution can be located that matches the issue or complaint, the available solution can be provided to the user 110 by the customer support system 100. If a matching solution cannot be found, the issue or complaint can be categorized and forwarded to a corresponding customer support team 140. The customer support team 140 can determine a solution, update the available solutions 130, and provide the solution to the user 110. If the issue or complaint is non-technical, the customer support system can set up a time for the user 110 to meet with the customer support team, for example at a local facility or by teleconference.

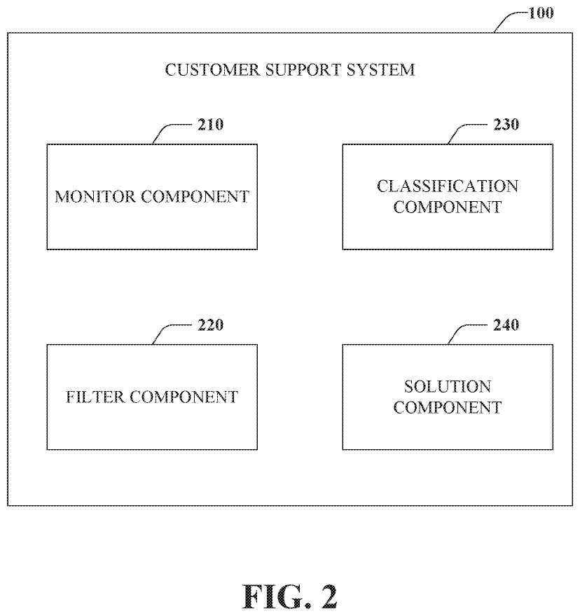

FIG. 2 illustrates a customer support system 100 for complaint management. The system includes a monitor component 210. The monitor component 210 monitors social media data related to an entity. The entity can be a company, corporation, financial institution, and/or the like. In one instance, the entity can have a social media presence. For example, company X can have accounts on a photo-sharing site, a social network site, a microblog site, and/or the like. The social media presence can provide a mode for customers to interact with the entity. Customers of the entity can have one or more social media accounts.

The monitor component 210 can capture at least one data point as part of the social media data. For example, the monitor component 210 captures at least one of direct messages, public messages, social media mentions, reactions, tags, hashtags, images, videos, text, customer sentiments and/or the like as a data point of the social media data. In some embodiments, the monitor component 210 stores the social media data for subsequent analysis. In other embodiments, the monitor component 210 can provide data for near real time analysis.

The system 100 includes a filter component 220. The filter component 220 can determine a subset of social media data. In some embodiments, the filter component 220 generates a subset of social media data including data points that are negatively associated with the entity. The filter component 220 analyzes the social media data according to various techniques to determine a sentiment of each data point in the social media data. In some embodiments, the filter component 220 employs a natural language processing technique or a content analysis technique to determine the sentiment of each data point in the social media data. For example, the filter component 220 can use natural language processing to search for negative words and/or emoji to determine negative sentiment for a data point. In another example, content analysis can search for hashtags or other identifiers to determine a negative sentiment or entity identification. In some embodiments, the filter component 220 can analyze audio, video, and/or images for sentiments regarding the entity.

The system includes a classification component 230. The classification component 230 classifies data in the subset of social media data by issue. The classification component 230 determines whether a data point in the subset is a technical complaint or non-technical complaint. In some embodiments, the classification component 230 employs a natural language processing technique or a content analysis technique to determine the classification of each data point in the social media data. For example, the classification component 230 can use natural language processing to search for technical words and/or feeling/sentiment words to determine the classification of the data point. In another example, content analysis can search for hashtags or other identifiers to determine a technical complaint or non-technical complaint. A technical complaint, for example, can be an issue for a customer attempting to log in to their online account with the entity. An example non-technical complaint could be a comment about a service provided by the entity to the customer.

The system 100 includes a solution component 240. The solution component 240 determines a solution for a data point based on the classification. The solution component 240 receives a classification of a negative data point from the classification component 230. If the classification of a data point is non-technical, the solution component 240 determines at least one solution option for the customer for the data point. For example, the solution component 240 can determine an appointment with a customer service representative or support team will address the non-technical complaint of the customer. In some embodiments, the solution component 240 can provide the solution option to the customer over the customer social media account. In other embodiments, the solution component 240 can determine customer contact information and provide the solution via the customer contact information.

If the classification of a data point is technical, the solution component 240 determines a technical solution for the customer. The solution component 240 can determine at least one similar previous technical issue. The solution component 240 compares the data point to previous social media complaints, previous technical solutions, and/or the like. For example, the solution component 240 can match words, hashtags, and/or the like to previous social media complaints. The previous social media complain is associated with a previous technical solution. The solution component 240 can provide the previous technical solution to the customer to address the customer's complaint. In some embodiments, the solution component 240 can provide the previous technical solution to the customer over the customer social media account. In other embodiments, the solution component 240 can determine customer contact information and provide the technical solution via the customer contact information.

In some embodiments, the solution component 240 cannot match the data point to a previous social media complaint or there is no technical solution associated with the previous social media complaint. In this case, the solution component 240 can escalates the data point to a support team to provide a technical solution. The support team can contact the customer over the customer social media account. The solution component 240 can determine customer contact information and contact the customer via the customer contact information. In this embodiment, the solution component 240 can monitor the support team to learn and store a provided technical solution to the customer for future data points.

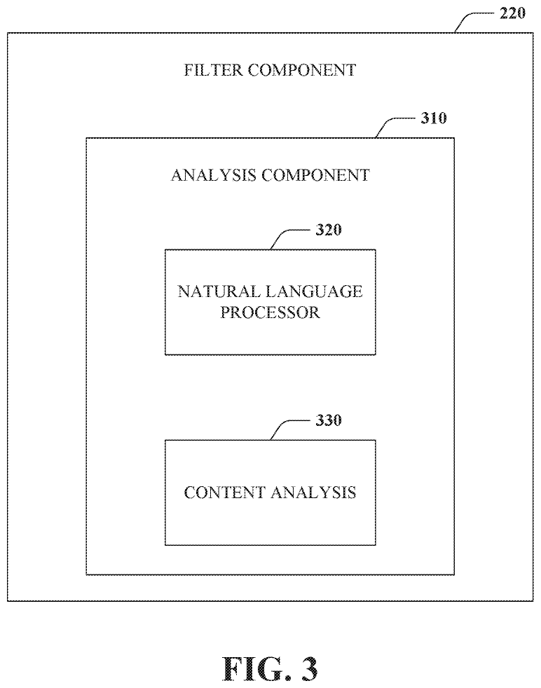

FIG. 3 illustrates a detailed component diagram of the filter component 220. The filter component 220 includes an analysis component 310. The analysis component 310 can determine a subset of social media data. In some embodiments, the analysis component 310 generates a subset of social media data for data points that are negatively associated with the entity. The analysis component 310 analyzes the social media data according to various techniques to determine a sentiment of each data point.

In some embodiments, the analysis component 310 includes a natural language processor 320. The natural language processor 320 employs a natural language processing technique to determine the sentiment of each data point in the social media data. For example, the filter component 220 can use natural language processing to search for negative words and/or emojis to determine negative sentiment for a data point.

In other embodiments, the analysis component 310 includes a content analyzer 330. The content analyzer 330 employs a content analysis technique to search for hashtags or other identifiers to determine a negative sentiment or entity identification. In some embodiments, the content analyzer 330 analyzes audio, video, and/or images to determine sentiments regarding the entity.

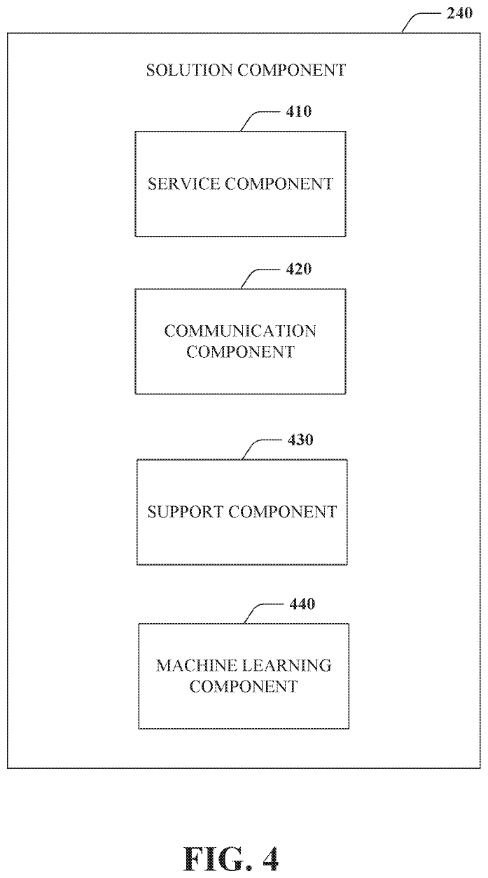

FIG. 4 illustrates a component diagram of an example solution component 240. The solution component 240 determines a solution for a data point based on the classification. The solution component 240 receives a classification of a negative data point from the classification component 230. The solution component 240 includes a service component 440. If the classification of a data point is non-technical, the service component 410 determines at least one solution option for the customer for the data point. For example, the service component 410 can determine an appointment with a customer service representative or support team will address the non-technical complaint of the customer.

The solution component 240 includes a communication component 420. In some embodiments, the communication component 420 can provide the solution option to the customer over the customer social media account. In other embodiments, the communication component 420 can determine customer contact information and provide the solution via the customer contact information.

The solution component 240 includes a support component 430. If the classification of a data point is technical, the support component 430 determines a technical solution for the customer. The support component 430 can determine at least one similar previous technical issue. The support component 430 compares the data point to previous social media complaints, previous technical solutions, and/or the like. For example, the support component 430 can match words, hashtags, and/or the like to previous social media complaints. The previous social media complain is associated with a previous technical solution. The support component 430 can provide the previous technical solution to the customer to address the customer's complaint.

In some embodiments, the communication component 420 can provide the previous technical solution to the customer over the customer social media account. For example, the solution can be provided in a response to a social media post specifying a technical complaint. In other embodiments, the communication component 420 can determine customer contact information and provide the technical solution via the customer contact information.

In some embodiments, the support component 430 cannot match the data point to a previous social media complaint or there is no technical solution associated with the previous social media complaint, the service component 410 can escalate the data point to a support team to provide a technical solution. The support team can contact the customer over the customer social media account. The communication component 420 can determine customer contact information and contact the customer via the customer contact information. The solution component 240 includes a machine learning component 440. The machine learning component 440 can monitor the support team to learn and store a provided technical solution to the customer for future data points and/or technical solutions.

The aforementioned systems, architectures, platforms, environments, or the like have been described with respect to interaction between several components. In one instance, such components can be embodied by computer executable instructions stored in memory that when executed by a processor causes the processor to perform operations that capture component function. Further, it should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull control model. The components may also interact with one or more other components not specifically described herein for sake of brevity, but known by those of skill in the art.

Furthermore, various portions of the disclosed systems above and methods below can include or employ artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, natural language processing, automatic categorization, classifiers . . . ). Such components, among others, can automate certain mechanisms or processes performed thereby to make portions of the systems and methods more adaptive as well as efficient and intelligent. By way of example, and not limitation, such mechanisms can be utilized by the classification component 230 to automatically classify or cluster social media data by issue and by the solution component 240 to automatically infer a solution to an issue or complaint.

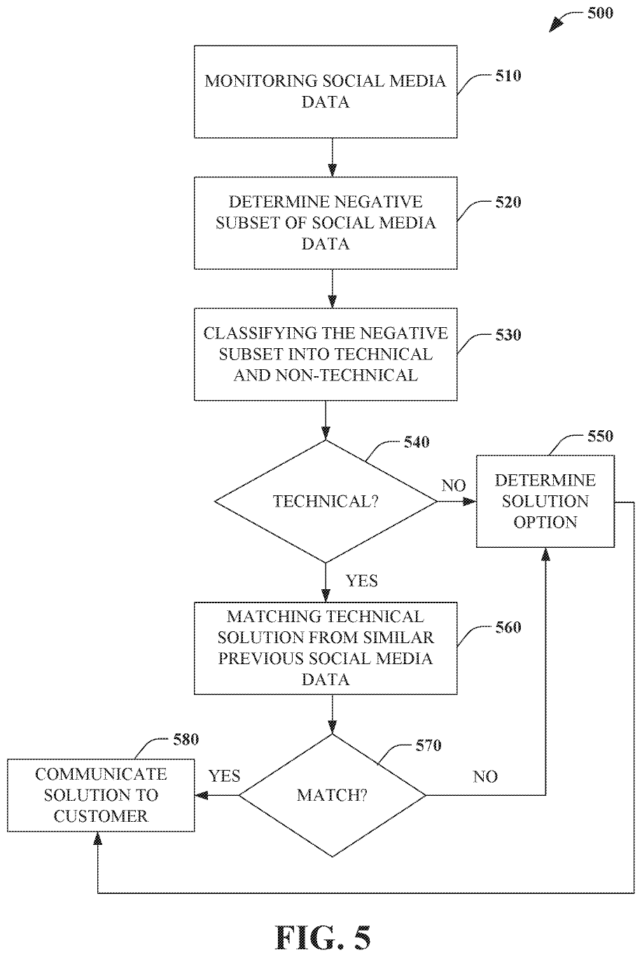

In view of the exemplary systems described above, methods that may be implemented in accordance with the disclosed subject matter will be better appreciated with reference to the flow chart diagram of FIG. 5. While for purposes of simplicity of explanation, the methods are shown and described as a series of blocks, it is to be understood and appreciated that the disclosed subject matter is not limited by the order of the blocks, as some blocks may occur in different orders and/or concurrently with other blocks from what is depicted and described herein. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block.

FIG. 5 illustrates a method 500 for customer support complaint management. The method 500 can be implemented by the customer support system 100 and various components thereof. At 510, social media data is monitored across one or more platforms. The social media data associated or related to an entity is monitored for further analysis. At 520, a negative subset of the social media data is determined. The negative subset includes social media data that have been analyzed and determined to have a negative sentiment or complaint regarding the entity, including a product or service of the entity.

At 530, the subset is classified into technical and non-technical classifications. A technical classified data point is a social media complaint regarding a technical issue. A non-technical classified data point is a social media complaint specific to a customer regarding a non-technical issue. At 540, if the classification is non-technical, a solution option is determined at 550. For example, the solution option can be scheduling an appointment with a support team member.

At 540, if the classification is technical, a previous technical solution is determined by matching the data point to a similar previous social media data point or complaint at 560. In some embodiments, at 570, if a match cannot be determined, a solution option is determined at 550 as described above. At 570, if a match is found, the technical solution is communicated to the customer at 580.

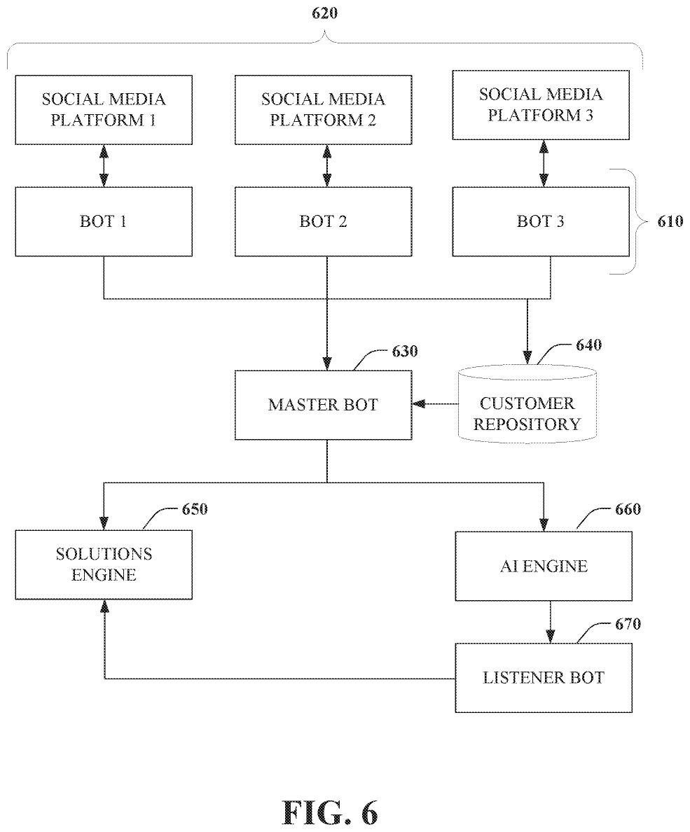

Turning attention to FIG. 6, a particular implementation of the customer support system 100 is illustrated to facilitate clarity and understanding. The system includes a plurality of internet bots 610 connected to numerous social media platforms 620, and a master bot 630 integrated with the plurality of internet bots 610. These bots, also known as web robots, execute scripts over the Internet to perform various tasks automatically. The social media platforms 620, indicated as social media platform 1-3, can be any social networking channels in which a user is active. The internet bots 610 are capable of making application programming interface (API) calls with an allocated social media platform to retrieve social feeds. The internet bots 610 can be communicatively coupled with customer repository 640, which stores profiles of customers of an entity, directly or through the master bot 630. In one instance, the master bot 630 can be a smart internet bot capable of identifying an issue as one of a technical issue and a non-technical issue. The master bot 630 is further connected to a solutions engine 650, an artificial intelligence (AI) engine 660, and a listener bot 670 to provide appropriate response to the customer issue.

In operation, when a person uploads a post or updates status in a social media platform by tagging, for example, a bank product or a bank related service, the internet bot 610 allocated to the social media platform 620 identifies the post using hash tags, and also identifies the user who posted the issue using customer profile stored in the customer repository 640. If the user is identified as a customer of the bank, the system initiates the process of understanding the issue and providing solution to the user. If the user is identified as not a customer of the bank, then the internet bot 610 requests more details from the user to verify the identity of the customer. Upon identification, the internet bot 610 retrieves the content of the post and sends to the master bot 630, which performs content analysis to understand or identify the issue posted. In one embodiment, if the customer posts audio/video about the issue, the master bot 630 uses natural language processing techniques to process speech to text. In another embodiment, the internet bot 610 also uses behavioral analysis techniques to understand customer emotion and criticality of the issue posted. In one example, the master bot 630 summarizes the data received from the internet bots 610 of multiple social media platforms and identifies and issue or complaint as technical or non-technical based on content analysis.

If the issue or complaint is identified as technical, the master bot 630 sends the summarized data to the solutions engine 650. The solutions engine 650 comprises previously addressed technical issues, and corresponding solutions. In one embodiment, the solutions engine 650 searches for a pattern of existing issues matching with the issue/complaint identified by the master bot 630 using machine learning techniques. The solutions engine 650 maps the tags, keywords, phrases identified in the customer's post with the available issue patterns to determine if the issue is addressed earlier. Upon identifying the existence of issue in the previously addressed issues, the solutions engine 650 provides the customer with the available solution resolving the complaint. In another embodiment, if the solutions engine 650 determines the issue identified as a new issue if the identified issue is not matching with the existing issues, the solutions engine 650 forwards the issue to the AI engine 660. The AI engine 660 predicts the category of the issue (e.g., network issue, infrastructure issue, application issue . . . ) based on the product specified in customer complaint and by matching the patterns of a number of new issues. In one example, the AI engine 660 may be a predictive modelling engine. The AI engine 660 further forwards the new issue to the customer support team for further classifying the relevant issue. Further, the customer support team may determine the solution to the new issue by opening a communication channel. The communication channel enables a customer support team to consult stakeholders or the product managers of the particular product on which the issue is raised and obtain the desired solution for the identified problem/issue. The customer support team may upload or update the solution to the new issue in the solutions engine using the listener bot 670.

Further, if the smart master bot 630 identifies the issue as a non-technical issue, the master bot 630 can provide the users with the nearest bank or store to consult for resolving the issue. The master bot 630 may also provide the user with the options to book an appointment with a customer support team, special appointment for elderly customers and so on. The master bot 630 may also create a support ticket for the new issues based on the options selected by the customer. Thus, the system effectively provides solutions to the complaints or issues posted on bank product with quick and efficient response.

The subject disclosure pertains to a technical problem of providing customer support to individuals who express issues or complaints on different systems, namely a post on a social media platform as opposed to a customer support request. The problem is addressed with technical mechanisms by monitoring and analyzing social media posts to detect an issue or complaint with regard to a particular entity or product or services of the entity. Further, solutions for any detected issue or complaint can be determined automatically and provided to an individual, for instance in response the social media post or other communication medium. Consequently, customer support is improved and knowledge and management social media reputation is obtained.

The subject disclosure provides for various products and processes that perform, or are configured to provide customer support, for instance in response to social media posts. What follows are one or more exemplary systems and methods.

A method comprises: monitoring social media data related to an entity, the entity having a social media presence and customers of the entity having one or more social media accounts, wherein the social media data includes at least one data point; determining a subset of social media data that are negatively associated with the entity; classifying data in the subset of social media data; and determining a solution based on the classification, wherein the solution mitigates the subset of social media data that is negatively associated with the entity. The monitoring can further comprise capturing at least one of direct messages, public messages, social media mentions, reactions, tags, hashtags, or customer sentiments as a data point of the social media data. Determining the subset can further comprise analyzing the social media data according to a natural language processing technique or a content analysis technique to determine a sentiment of each data point in the social media data. Classifying can further comprise determining whether a data point in the subset is technical complaint or non-technical complaint. In one instance, when the data point can be classified as non-technical, the method can comprise determining at least one solution option for the customer and providing the option to the customer over the customer social media account. Providing the option can comprise up an appointment with a support team as the at least one solution option. The method can further comprise comprising determining a technical solution for the customer when the data point is classified as technical. Determining the technical solution can comprise determining at least one similar technical issue by comparing the data point to previous technical issues and previous technical solutions and providing a technical solution of the similar technical issue to the customer by way of the customer social media account. When a similar technical issue is unable to be determined, the method further comprises escalating the data point to a support team to provide a technical solution and machine learning and storing the provided technical solution for future data points.

A system comprises a processor coupled to a memory that stores executable instructions that when executed by the processor cause the processor to: monitor social media data related to an entity, the entity having a social media presence and customers of the entity having one or more social media accounts and wherein the social media data includes at least one data point; determine a subset of social media data that are negatively associated with the entity; classify data in the subset of social media data; and determine a solution based on the classification, wherein the solution mitigates the subset of social media data that is negatively associated with the entity. The system can further comprise instructions that cause the processor to capture at least one of direct messages, public messages, social media mentions, reactions, tags, hashtags, or customer sentiments as a data point of the social media data. Further instructions ca cause the processor to analyze the social media data according to a natural language processing technique or a content analysis technique to determine a sentiment of each data point in the social media data. The system can also include instructions that cause the processor to determine whether a data point, associated with a customer by way of a customer social media account, in the subset is technical complaint or non-technical complaint. Further instructions can cause the processor to determine at least one solution option for the customer when the data point is classified as non-technical and provide the solution option to the customer over the customer social media account. The at least one solution option can be an appointment with a support team in one instance. The system can further comprise instructions that cause the processor to determine a technical solution for the customer when the data point is classified as technical. The instructions can additionally cause the processor to determine at least one similar technical issue by comparing the data point to previous technical issues and previous technical solutions and provide a technical solution of the similar technical issue to the customer by way of the customer social media account. Further, the instructions can cause the processor to escalate the data point to a support team to provide a technical solution when a similar technical issue is cannot be determined and store the provided technical solution for future data points.

A computer readable medium can have instructions to control one or more processors to monitor social media data related to an entity, the entity having a social media presence and customers of the entity having one or more social media accounts, wherein the social media data includes at least one data point associated with a customer by way of a social media account; analyze the social media data according to a natural language processing technique or a content analysis technique to determine a sentiment of each data point in the social media data to determine a subset of social media data that are negatively associated with the entity; determine whether a data point in the subset is technical complaint or non-technical complaint; and determine a solution based on classification of the complaint, wherein the solution mitigates the subset of social media data that is negatively associated with the entity. Further, the computer-readable medium can have instructions that control the one or more processors to determine at least one solution option for the customer when the data point is classified as non-technical; determine a similar technical issue when the data point is classified as technical; and provide a technical solution of the similar technical issue to the customer by way of the customer social media account.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

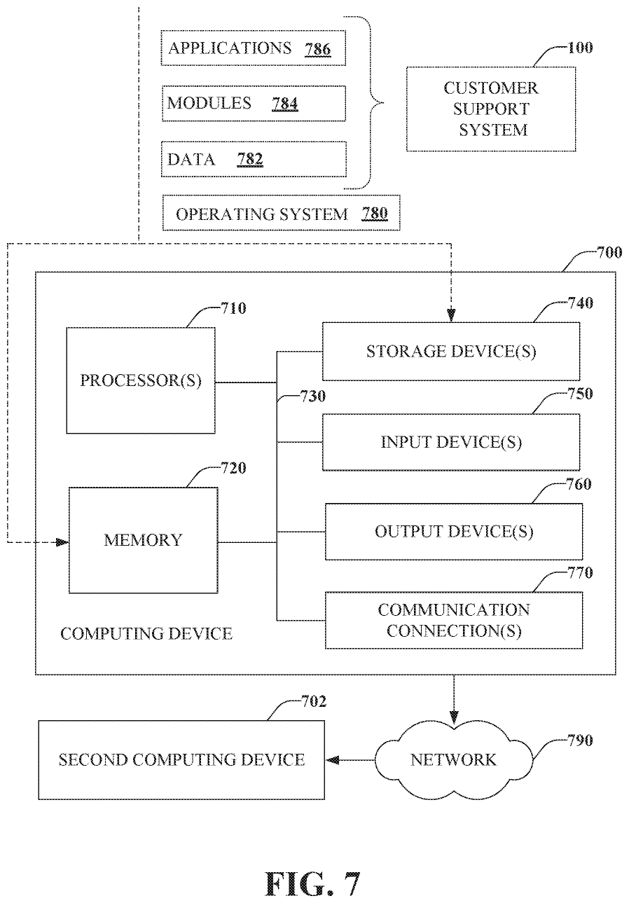

To provide a context for the disclosed subject matter, FIG. 7 as well as the following discussion are intended to provide a brief, general description of a suitable environment in which various aspects of the disclosed subject matter can be implemented. The suitable environment, however, is solely an example and is not intended to suggest any limitation as to scope of use or functionality.

While the above disclosed systems and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smart phone, tablet, watch . . . ), microprocessor-based or programmable consumer or industrial electronics, and the like. Aspects can also be practiced in distributed computing environments where tasks are performed by remote processing devices that are linked through a communications network. However, some, if not all aspects, of the disclosed subject matter can be practiced on stand-alone computers. In a distributed computing environment, program modules may be located in one or both of local and remote memory devices.

With reference to FIG. 7, illustrated is an example computing device 700 (e.g., desktop, laptop, tablet, watch, server, hand-held, programmable consumer or industrial electronics, set-top box, game system, compute node . . . ). The computing device 700 includes one or more processor(s) 710, memory 720, system bus 730, storage device(s) 740, input device(s) 750, output device(s) 760, and communications connection(s) 770. The system bus 730 communicatively couples at least the above system constituents. However, the computing device 700, in its simplest form, can include one or more processors 710 coupled to memory 720, wherein the one or more processors 710 execute various computer executable actions, instructions, and or components stored in the memory 720.

The processor(s) 710 can be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 710 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 710 can be a graphics processor unit (GPU) that performs calculations with respect to digital image processing and computer graphics.

The computing device 700 can include or otherwise interact with a variety of computer-readable media to facilitate control of the computing device to implement one or more aspects of the disclosed subject matter. The computer-readable media can be any available media that accessible to the computing device 700 and includes volatile and nonvolatile media, and removable and non-removable media. Computer-readable media can comprise two distinct and mutually exclusive types, namely storage media and communication media.

Storage media includes volatile and nonvolatile, removable and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computing device 700. Accordingly, storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media.

The memory 720 and storage device(s) 740 are examples of computer-readable storage media. Depending on the configuration and type of computing device, the memory 720 may be volatile (e.g., random access memory (RAM)), non-volatile (e.g., read only memory (ROM), flash memory . . . ) or some combination of the two. By way of example, the basic input/output system (BIOS), including basic routines to transfer information between elements within the computing device 700, such as during start-up, can be stored in nonvolatile memory, while volatile memory can act as external cache memory to facilitate processing by the processor(s) 710, among other things.

The storage device(s) 740 include removable/non-removable, volatile/non-volatile storage media for storage of vast amounts of data relative to the memory 720. For example, storage device(s) 740 include, but are not limited to, one or more devices such as a magnetic or optical disk drive, floppy disk drive, flash memory, solid-state drive, or memory stick.

Memory 720 and storage device(s) 740 can include, or have stored therein, operating system 780, one or more applications 786, one or more program modules 784, and data 782. The operating system 780 acts to control and allocate resources of the computing device 700. Applications 786 include one or both of system and application software and can exploit management of resources by the operating system 780 through program modules 784 and data 782 stored in the memory 720 and/or storage device(s) 740 to perform one or more actions. Accordingly, applications 786 can turn a general-purpose computer 700 into a specialized machine in accordance with the logic provided thereby.

All or portions of the disclosed subject matter can be implemented using standard programming and/or engineering techniques to produce software, firmware, hardware, or any combination thereof to control the computing device 700 to realize the disclosed functionality. By way of example and not limitation, all or portions of the customer support system 100 can be, or form part of, the application 786, and include one or more modules 784 and data 782 stored in memory and/or storage device(s) 740 whose functionality can be realized when executed by one or more processor(s) 710.

In accordance with one particular embodiment, the processor(s) 710 can correspond to a system on a chip (SOC) or like architecture including, or in other words integrating, both hardware and software on a single integrated circuit substrate. Here, the processor(s) 710 can include one or more processors as well as memory at least similar to the processor(s) 710 and memory 720, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the customer support system 100 and/or functionality associated therewith can be embedded within hardware in a SOC architecture.

The input device(s) 750 and output device(s) 760 can be communicatively coupled to the computing device 700. By way of example, the input device(s) 750 can include a pointing device (e.g., mouse, trackball, stylus, pen, touch pad . . . ), keyboard, joystick, microphone, voice user interface system, camera, motion sensor, and a global positioning satellite (GPS) receiver and transmitter, among other things. The output device(s) 760, by way of example, can correspond to a display device (e.g., liquid crystal display (LCD), light emitting diode (LED), plasma, organic light-emitting diode display (OLED) . . . ), speakers, voice user interface system, printer, and vibration motor, among other things. The input device(s) 750 and output device(s) 760 can be connected to the computing device 700 by way of wired connection (e.g., bus), wireless connection (e.g., Wi-Fi, Bluetooth . . . ), or a combination thereof.

The computing device 700 can also include communication connection(s) 770 to enable communication with at least a second computing device 702 by means of a network 790. The communication connection(s) 770 can include wired or wireless communication mechanisms to support network communication. The network 790 can correspond to a local area network (LAN) or a wide area network (WAN) such as the Internet. The second computing device 702 can be another processor-based device with which the computing device 700 can interact.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

1. A method, comprising:
simultaneously monitoring, by a plurality of internet bots connected to respective social media platforms, the respective social media platforms for social media data related to an entity, the entity having a social media presence, wherein the social media data includes one or more data points;
receiving, by a master bot and from at least one of the plurality of internet bots, the social media data related to the entity;
determining, by a filter component of a device, a subset of data points of the social media data that are negatively associated with the entity;
classifying, by the master bot, a data point in the subset of data points as either a technical complaint or a non-technical complaint; and
determining, by a solution component of the device, a solution based on the classification, wherein the solution mitigates the subset of data points of the social media data that are negatively associated with the entity, and wherein only in an instance in which the data point is classified as a technical complaint, determining the solution comprises:
automatically attempting to determine, by the solution component, a similar technical issue to the data point based on a comparison of the data point to previous technical issues associated with previous technical solutions, wherein the solution comprises a previous technical solution associated with the similar technical issue;
in an instance in which the similar technical issue is able to be determined:
automatically providing, by the solution component, the solution to a customer associated with the data point by way of a social media account associated with the customer; and
in an instance in which the similar technical issue is unable to be determined:
determining, by an artificial intelligence (AI) engine, an issue category for the data point based on a product associated with the entity specified by the data point;
escalating, by a service component of the device, the categorized data point to a support team to provide a technical solution;
automatically identifying, by a machine learning component, the technical solution for the technical complaint via a communication channel facilitating communication between the support team and personnel associated with the product; and
storing, by the machine learning component of the device, the technical solution provided by the support team for one or more future data points.

2. The method of claim 1, the monitoring further comprising:
capturing at least one of direct messages, public messages, social media mentions, reactions, tags, hashtags, or customer sentiments as the one or more data points of the social media data.

3. The method of claim 1, determining the subset further comprising:
analyzing the social media data according to a natural language processing technique or a content analysis technique to determine a sentiment of each data point of the social media data.

4. (canceled)

5. The method of claim 1, further comprising, in an instance in which the data point is classified as a non-technical complaint:
determining at least one solution option for the customer; and
providing the at least one solution option to the customer over the social media account associated with the customer.

6. The method of claim 5, wherein the at least one solution option comprises setting up an appointment with the support team.

7. (canceled)

8. (canceled)

9. (canceled)

10. A system, comprising:
a processor coupled to a memory that stores executable instructions that when executed by the processor cause the processor to:
simultaneously monitor, by a plurality of internet bots connected to respective social media platforms, the respective social media platforms for social media data related to an entity, the entity having a social media presence, wherein the social media data includes one or more data points;
receive, by a master bot and from at least one of the plurality of internet bots, the social media data related to the entity
determine a subset of data points of the social media data that are negatively associated with the entity;
classify, by the master bot, a data point in the subset of data points as either a technical complaint or a non-technical complaint; and
determine a solution based on the classification, wherein the solution mitigates the subset of data points of the social media data that are negatively associated with the entity, and wherein only in an instance in which the data point is classified as a technical complaint, determining the solution comprises:
automatically attempting to determine a similar technical issue to the data point based on a comparison of the data point to previous technical issues associated with previous technical solutions, wherein the solution comprises a previous technical solution associated with the similar technical issue;
in an instance in which the similar technical issue is able to be determined:
automatically providing the solution to a customer associated with the data point by way of a social media account associated with the customer;
in an instance in which the similar technical issue is unable to be determined:
determining an issue category for the data point based on a product associated with the entity specified by the data point;
escalating the categorized data point to a support team to provide a technical solution;
automatically identifying the technical solution for the technical complaint via a communication channel facilitating communication between the support team and personnel associated with the product; and
storing the technical solution provided by the support team for one or more future data points.

11. The system of claim 10, further comprising instructions that cause the processor to capture at least one of direct messages, public messages, social media mentions, reactions, tags, hashtags, or customer sentiments as the one or more data points of the social media data.

12. The system of claim 10, further comprising instructions that cause the processor to analyze the social media data according to a natural language processing technique or a content analysis technique to determine a sentiment of each data point of the social media data.

13. (canceled)

14. The system of claim 10, further comprising instructions that cause the processor to, in an instance in which the data point is classified as a non-technical complaint:
determine at least one solution option for the customer; and
provide the at least one solution option to the customer over the social media account associated with the customer.

15. The system of claim 14, wherein the at least one solution option comprises an appointment with the support team.

16. (canceled)

17. (canceled)

18. (canceled)

19. A non-transitory computer readable medium having instructions to control one or more processors configured to:
simultaneously monitor, by a plurality of internet bots connected to respective social media platforms, the respective social media platforms for social media data related to an entity, the entity having a social media presence, wherein the social media data includes one or more data points;
receive, by a master bot and from at least one of the plurality of internet bots, the social media data related to the entity;
determine a subset of data points of the social media data that are negatively associated with the entity;
classify, by the master bot, a data point within the subset of data points as either a technical complaint or a non-technical complaint; and
determine a solution based on the classification, wherein the solution mitigates the subset of data points of the social media data that are negatively associated with the entity, and wherein only in an instance in which the data point is classified as a technical complaint, determining the solution comprises:
automatically attempting to determine a similar technical issue to the data point based on a comparison of the data point to previous technical issues associated with previous technical solutions, wherein the solution comprises a previous technical solution associated with the similar technical issue;
in an instance in which the similar technical issue is able to be determined:
automatically providing the solution to a customer associated with the data point by way of a social media account associated with the customer; and
in an instance in which the similar technical issue is unable to be determined:
determining an issue category for the data point based on a product associated with the entity specified by the data point;
escalating the categorized data point to a support team to provide a technical solution;
automatically identifying the technical solution for the technical complaint via a communication channel facilitating communication between the support team and personnel associated with the product; and
storing the technical solution provided by the support team for one or more future data points.

20. The non-transitory computer readable medium of claim 19, wherein the one or more processors are further configured to, in an instance in which the data point is classified as a non-technical complaint:
determine at least one solution option for the customer; and
provide the at least one solution option to the customer over the social media account associated with the customer.
